(19) United States
(12) Patent Application Publication
(10) Pub. No.: US 2020/0021022 A1
(43) Pub. Date: Jan. 16, 2020

(54) ANTENNA DEVICE, AND WIRELESS COMMUNICATION DEVICE

(71) Applicant: Fujikura Ltd., Tokyo (JP)

(72) Inventor: Daisuke Awaji, Sakura-shi (JP)

(73) Assignee: Fujikura Ltd., Tokyo (JP)

(21) Appl. No.: 16/493,053

(22) PCT Filed: Dec. 27, 2017
(86) PCT No.: PCT/JP2017/047015

§ 371 Date: Sep. 11, 2019

(30) Foreign Application Priority Data
Mar. 13, 2017 (JP) 2017-047373

(51) Int. Cl. H01Q 3/01; H01Q 1/38; H01Q 1/24

(52) U.S. Cl. CPC H01Q 3/01; H01Q 1/24; H01Q 1/38

(57) ABSTRACT

The present invention provides an antenna device whose radiation direction is adjustable and which can be manufactured at a lower cost than in the case of a conventional antenna device. An antenna device (1) includes a dielectric substrate (11), a ground conductor (12) provided on a first main surface of the dielectric substrate (11), and an antenna conductor (13) provided on a second main surface of the dielectric substrate (11). The ground conductor (12) is made of a conductor material having a thermal expansion coefficient higher than that of a dielectric material of which the dielectric substrate (11) is made. A heating wire (16) which serves as a heating/cooling mechanism is provided inside the dielectric substrate (11).

### TECHNICAL FIELD

The present invention relates to a substrate-type antenna device. The present invention also relates to a wireless device including the antenna device.

### BACKGROUND ART

With the popularization of wireless communication, an antenna device is widely used. In particular, a light and thin substrate-type antenna device is widely used as an antenna device incorporated in various types of wireless device. Note that “substrate-type antenna device” refers to an antenna device that includes a dielectric substrate, a ground conductor provided on one main surface of the dielectric substrate, and an antenna conductor provided on the other main surface of the dielectric substrate.

For example, in a case where an antenna conductor is provided on a main surface of a printed wiring board described in Patent Literature 1 which main surface is opposite to the other main surface on which a ground conductor is provided, it is possible to obtain a substrate-type antenna device that is less likely to warp.

### CITATION LIST

### Patent Literature

Patent Literature 1

Japanese Patent Application Publication, Tokukai, No. 2015-08286 (Publication Date: Jan. 15, 2015)

### SUMMARY OF INVENTION

### Technical Problem

In a highly directional antenna device such as a millimeter wave (30 GHz to 300 GHz) antenna, it is important to adjust a radiation direction. This is because in a case where the radiation direction is not adjusted in accordance with a position of a communication partner device, significant deterioration in communication quality occurs. Methods for adjusting a radiation direction of a substrate-type antenna device are roughly categorized into electrical methods and mechanical methods.

A substrate-type antenna device whose radiation direction can be adjusted by an electrical method is, for example, a phased array antenna. In the phased array antenna, a radiation direction of the phased array antenna is adjusted by controlling a phase of a high frequency signal supplied to each antenna conductor constituting the phased array antenna. However, since the phased array antenna requires a phase shifter for changing the phase of the high frequency signal supplied to the each antenna conductor, a control circuit for controlling the phase shifter, and/or the like, it is difficult to provide the phased array antenna at low cost.

As a method of mechanically adjusting a radiation direction of a substrate-type antenna device, it is an option to mechanically change an orientation of the antenna device itself, and it is also an option to mechanically change an orientation of a support supporting the antenna device. The former is a method suitable for an antenna device including a dielectric substrate having high rigidity such as a rigid substrate, and the latter is a method suitable for an antenna device including a dielectric substrate having low rigidity such as a flexible substrate. However, both of these methods require a mechanism such as a hinge, a gear, and/or a motor. Therefore, it is not easy to provide such an antenna device at low cost.

The present invention has been made in view of the above problems. A main object of the present invention is to provide, at a lower cost than in the case of a conventional substrate-type antenna device, a substrate-type antenna device whose radiation direction is adjustable.

### Solution to Problem

In order to attain the object, an antenna device in accordance with an aspect of the present invention is an antenna device, including: a dielectric substrate; a ground conductor provided on a first main surface of the dielectric substrate and made of a conductor material having a thermal expansion coefficient higher than that of a dielectric material of which the dielectric substrate is made; an antenna conductor provided on a second main surface of the dielectric substrate; and a heating/cooling mechanism which heats the dielectric substrate and the ground conductor.

In order to attain the object, an adjustment method in accordance with an aspect of the present invention is a method for adjusting a radiation direction of an antenna device, the antenna device including: a dielectric substrate; a ground conductor provided on a first main surface of the dielectric substrate and made of a conductor material having a thermal expansion coefficient higher than that of a dielectric material of which the dielectric substrate is made; and an antenna conductor provided on a second main surface of the dielectric substrate, the method comprising: a heating/cooling step of controlling an orientation of the antenna conductor by heating or cooling the dielectric substrate and the ground conductor.

### Advantageous Effects of Invention

According to an aspect of the present invention, a substrate-type antenna device whose radiation direction is adjustable can be provided at a lower cost than in the case of a conventional substrate-type antenna device.

### BRIEF DESCRIPTION OF DRAWINGS

FIG. 1 is a view showing a configuration of an antenna device in accordance with Embodiment 1 of the present invention. (a) of FIG. 1 is a plan view of the antenna device, (b) of FIG. 1 is an AA′ cross-sectional view of the antenna device, and (c) of FIG. 1 is a BB′ cross-sectional view of the antenna device.

FIG. 2 is a view illustrating an effect of the antenna device of FIG. 1. (a) of FIG. 2 is an AA′ cross-sectional view of the antenna device which has not bent and (b) of FIG. 2 is an AA′ cross-sectional view of the antenna device which has bent.

FIG. 3 is a view illustrating Modified Example 1 of the antenna device of FIG. 1. (a) of FIG. 3 is a plan view of the antenna device and (b) of FIG. 3 is an AA′ cross-sectional view of the antenna device.

FIG. 4 is a view illustrating Modified Example 2 of the antenna device of FIG. 1. (a) of FIG. 4 is a plan view of the antenna device and (b) of FIG. 4 is an AA′ cross-sectional view of the antenna device.

FIG. 5 is a view illustrating a configuration of an antenna device in accordance with Embodiment 2 of the present invention. (a) of FIG. 5 is a plan view of the antenna device, (b) of FIG. 5 is an AA′ cross-sectional view of the antenna device, and (c) of FIG. 5 is a BB′ cross-sectional view of the antenna device.

### DESCRIPTION OF EMBODIMENTS

### Embodiment 1

Configuration of Antenna Device

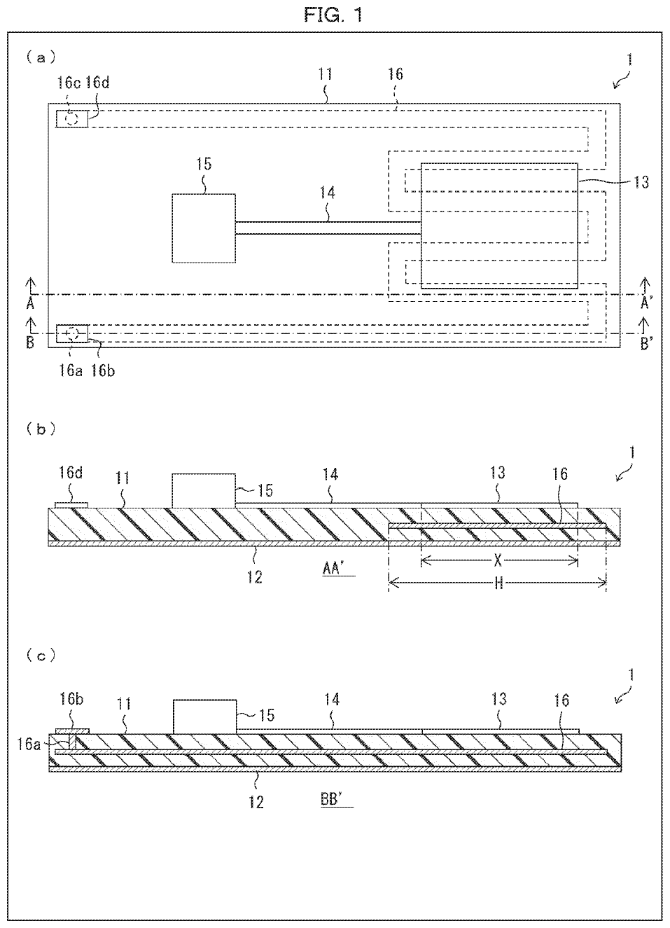

The following description will discuss, with reference to FIG. 1, a configuration of an antenna device 1 in accordance with Embodiment 1 of the present invention. (a) of FIG. 1 is a plan view of the antenna device 1, (b) of FIG. 1 is an AA′ cross-sectional view of the antenna device 1, and (c) of FIG. 1 is a BB′ cross-sectional view of the antenna device 1.

As illustrated in FIG. 1, the antenna device 1 includes a dielectric substrate 11, a ground conductor 12, an antenna conductor 13, a signal line 14, an integrated circuit 15, and a heating wire 16.

The dielectric substrate 11 is a plate-like member made of a dielectric and has flexibility. A material of the dielectric substrate 11 can be a dielectric material having a thermal expansion coefficient lower than that of a conductor material (described later) of which the ground conductor 12 is made. Examples of a suitable material for the dielectric substrate 11 encompass a fluorinated resin such as a liquid crystal polymer (linear expansion coefficient in the MD: 0.001×10⁻⁵/° C. to 2.0×10⁻⁵/° C., linear expansion coefficient in the TD: 5.0×10⁻⁵/° C. to 10.0×10⁻⁵/° C.), polyimide (linear expansion coefficient: 10×10⁻⁵/° C. to 40×10⁻⁵/° C.), and perfluoropolyethylene (linear expansion coefficient: 10×10⁻⁵). Among the six faces constituting the surfaces of the dielectric substrate 11, two surfaces having the largest areas are hereinafter referred to as main surfaces. One of the two main surfaces is called a first main surface, and the other is called a second main surface.

On the first main surface of the dielectric substrate 11, the ground conductor 12 is provided. The ground conductor 12 is a plate-like or film-like member made of a conductor such as a metal, and covers the entire first main surface of the dielectric substrate 11. A material of the ground conductor 12 may be a conductor material having a thermal expansion coefficient higher than that of the above-described dielectric material of which the dielectric substrate 11 is made. Examples of a suitable material for the ground conductor 12 encompass aluminum (thermal expansion coefficient: 23.0×10⁻⁵/° C.), copper (thermal expansion coefficient: 16.8×10⁻⁵/° C.), and gold (thermal expansion coefficient: 14.3×10⁻⁵/° C.).

On the second main surface of the dielectric substrate 11, the antenna conductor 13 and the signal line 14 drawn out from the antenna conductor 13 are provided. The antenna conductor 13 is a pattern made of a conductor such as a metal. The antenna conductor 13 converts a high frequency signal into an electromagnetic wave (at the time of transmission) and converts an electromagnetic wave into a high frequency signal (at the time of reception). A shape of the antenna conductor 13 is determined according to an antenna characteristic required of the antenna device 1. The signal line 14 is a strip-shaped pattern made of a conductor such as a metal. The signal line 14 constitutes a microstrip line together with the ground conductor 12 provided on the first main surface of the dielectric substrate 11. In this microstrip line, a high frequency signal inputted to the antenna conductor 13 is transmitted (at the time of transmission) and a high frequency signal outputted from the antenna conductor 13 is transmitted (at the time of reception). A tip of the signal line 14 serves as an electrode pad for connecting a signal terminal of the integrated circuit 15 thereto.

On the second main surface of the dielectric substrate 11, the integrated circuit 15 is mounted. The integrated circuit 15 generates (at the time of transmission) a high frequency signal to be inputted to the antenna conductor 13, by modulating a carrier wave signal with use of a transmission signal. The integrated circuit 15 also generates (at the time of receiving) a received signal by demodulating a high frequency signal outputted from the antenna conductor 13. On a back surface of the integrated circuit 15, a signal terminal (not illustrated) is provided. The signal terminal is connected to the tip of the signal line 14 described above. Output (transmission) of a high frequency signal from the integrated circuit 15 to the signal line 14 and input (reception) of a high frequency signal from the signal line 14 to the integrated circuit 15 are performed through the signal terminal.

Inside the dielectric substrate 11, the heating wire 16, which is a nichrome wire or the like, is provided. One end of the heating wire 16 is connected to a land 16b, which is provided on the second main surface of the dielectric substrate 11, through a via 16a. The other end of the heating wire 16 is connected to a land 16d, which is provided on the second main surface of the dielectric substrate 11, through the via 16c. In a case where a voltage is applied between the land 16b and the land 16d, an electric current flows through the heating wire 16, and the dielectric substrate 11 and the ground conductor 12 are heated by Joule heat generated by the heating wire 16.

Note that in a case where the heating wire 16 meanders inside the dielectric substrate 11, it is possible to selectively heat a portion of the dielectric substrate 11 and a portion of the ground conductor 12. In Embodiment 1, as illustrated in FIG. 1, the heating wire 16 meanders in a region H including a region X in which the antenna conductor 13 is provided. Accordingly, portions of the dielectric substrate 11 and the ground conductor 12 which portions are included in the region H are selectively heated. Of the antenna device 1, the region X in which the antenna conductor 13 is provided is hereinafter referred to as “antenna conductor-provided region” (corresponding to “first region” in the claims) and the region H in which the heating wire 16 meanders is hereinafter referred to as “region to be heated” (corresponding to “second region” in the claims).

Note that although Embodiment 1 discusses an example configuration in which the integrated circuit 15 is mounted on the second main surface of the dielectric substrate 11, the present invention is not limited to such a configuration. That is, the integrated circuit 15 may be mounted on the first main surface of the dielectric substrate 11. Further, in Embodiment 1, the integrated circuit 15 may be mounted on one of the first main surface and the second main surface of the dielectric substrate 11, or may be mounted on both the first main surface and the second main surface of the dielectric substrate 11. In this instance, a portion of the signal line 14 is provided on the first main surface of the dielectric substrate 11 and connected to the integrated circuit 15, and the remaining portion of the signal line 14 is provided on the second main surface of the dielectric substrate 11 and connected to the antenna conductor 13. Then, the portion of the signal line 14 provided on the first main surface of the dielectric substrate 11 and the remaining portion of the signal line 14 provided on the second main surface of the dielectric substrate 11 are connected to each other by a through via that passes through the dielectric substrate 11. The ground conductor 12 is patterned on the first main surface of the dielectric substrate 11 so as not to be in contact with the integrated circuit 15 and the signal line 14.

Effect of Antenna Device

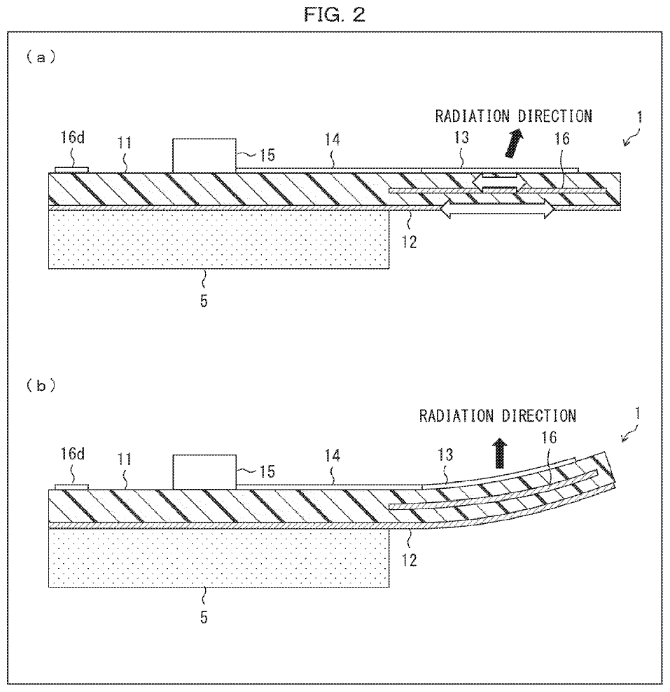

The following description will discuss an effect of the antenna device 1 with reference to FIG. 2. (a) of FIG. 2 is an AA′ cross-sectional view of the antenna device 1 which has not bent. (b) of FIG. 2 is an AA′ cross-sectional view of the antenna device 1 which has bent.

In the antenna device 1, the dielectric substrate 11 and the ground conductor 12 are heated in the region to be heated H, as described above. Then, as illustrated in (a) of FIG. 2, the dielectric substrate 11 and the ground conductor 12 thermally expand in the region to be heated H. At this time, since a thermal expansion coefficient of the ground conductor 12 is higher than that of the dielectric substrate 11, an expansion amount of the ground conductor 12 is greater than that of the dielectric substrate 11. Accordingly, the antenna device 1 bends in the region to be heated H so that the first main surface of the dielectric substrate 11 forms a protruding surface. At this time, in a case where a back surface of the antenna device 1 (a main surface of the antenna device 1 which main surface is on a side of the first main surface of the dielectric substrate 11) is fixed to a support 5 outside the region to be heated H, an orientation of the antenna conductor 13 provided inside the region to be heated H is changed as illustrated in (b) of FIG. 2. This causes a change in radiation direction (maximum gain direction) of an electromagnetic wave emitted from the antenna device 1.

In a case where the voltage applied to the heating wire 16 is increased so as to increase an amount of heat generated from the heating wire 16, the antenna device 1 bends to a greater extent. In a case where the voltage applied to the heating wire 16 is decreased so as to decrease an amount of heat generated from the heating wire 16, the antenna device 1 bends to a lesser extent. As such, it is possible in the antenna device 1 to control the orientation of the antenna conductor 13 by changing a level of the voltage applied to the heating wire 16. That is, a radiation direction (maximum gain direction) of the antenna conductor 13 can be controlled by changing the level of the voltage applied to the heating wire 16. Note that the level of the voltage applied to the heating wire 16 can be controlled by, for example, a control section (not illustrated) that is incorporated in a wireless device (not illustrated) together with the antenna device 1.

### Modified Example 1 of Antenna Device

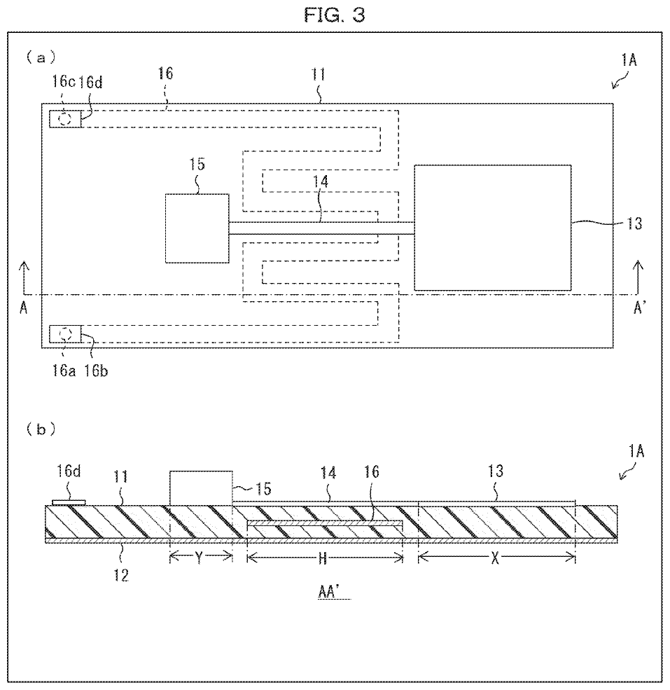

The following description will discuss, with reference to FIG. 3, Modified Example 1 (hereinafter referred to as an antenna device 1A) of the antenna device 1. (a) of FIG. 3 is a plan view of the antenna device 1A and (b) of FIG. 3 is an AA′ cross-sectional view of the antenna device 1A.

The antenna device 1 and the antenna device 1A differ from each other in a wiring path of the heating wire 16. The antenna device 1 is configured such that the region to be heated H, in which the heating wire 16 meanders, is provided so as to include the antenna conductor-provided region X, whereas the antenna device 1A is configured such that a region to be heated H, in which a heating wire 16 meanders, is provided so as not to include an antenna conductor-provided region X. More specifically, the region to be heated H, in which the heating wire 16 meanders, is provided between the antenna conductor-provided region X and an integrated circuit-mounted region Y. Note that the integrated circuit-mounted region Y refers to a region of the antenna device 1A in which region the integrated circuit 15 is mounted.

As with the antenna device 1, it is possible in the antenna device 1A to control an orientation of an antenna conductor 13 by changing a level of an electric current passed through the heating wire 16. Additionally, the antenna device 1A has the following advantages.

The first advantage is that since the antenna conductor-provided region X and the region to be heated H (a region in which the antenna device 1 bends) are at respective different locations, the antenna conductor 13 is less likely to be distorted even in a case where the antenna device 1A bends. Accordingly, the antenna device 1A is less likely to suffer deterioration in antenna characteristic caused by distortion of the antenna conductor 13.

The second advantage is that since the antenna conductor-provided region X and the region to be heated H (a region in which the heating wire 16 meanders) are at respective different locations, an electromagnetic field formed around the antenna conductor 13 is less likely to be distorted even in a case where an electric current flows through the heating wire 16. Accordingly, the antenna device 1A is less likely to suffer deterioration in antenna characteristic caused by distortion of an electromagnetic field formed around the antenna conductor 13.

### Modified Example 2 of Antenna Device

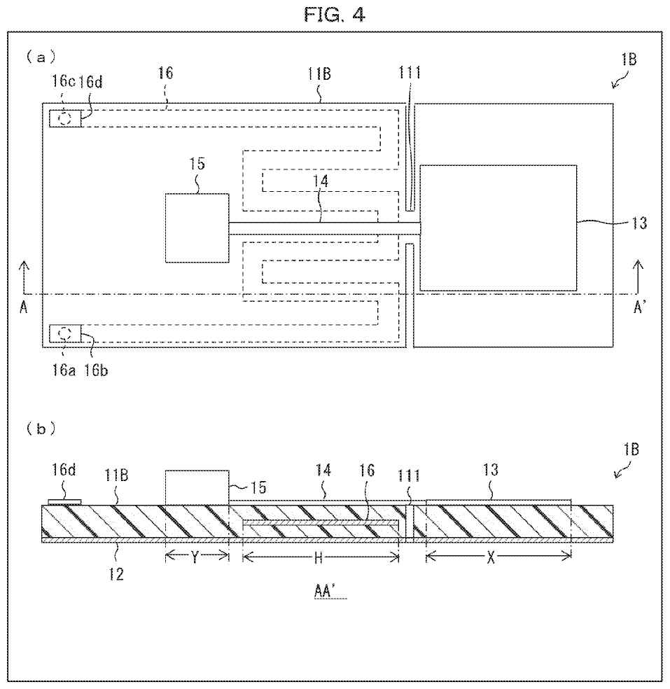

The following description will discuss, with reference to FIG. 4, Modified Example 2 (hereinafter referred to as an antenna device 1B) of the antenna device 1. (a) of FIG. 4 is a plan view of the antenna device 1B and (b) of FIG. 4 is an AA′ cross-sectional view of the antenna device 1B.

The antenna device 1B in accordance with Modified Example 2 is obtained by replacing the dielectric substrate 11 of the antenna device 1A in accordance with Modified Example 1 with a dielectric substrate 11B including a constricted section 111. The constricted section 111 is located between a region to be heated H and an antenna conductor-provided region X and inhibits thermal conduction from the region to be heated H to the antenna conductor-provided region X.

As with the antenna device 1 and the antenna device 1A, it is possible in the antenna device 1B to control an orientation of an antenna conductor 13 by changing a level of an electric current passed through a heating wire 16. Further, as with the antenna device 1A, the antenna device 1B has the first advantage that deterioration in antenna characteristic caused by distortion of the antenna conductor 13 is less likely to occur and the second advantage that deterioration in antenna characteristic caused by distortion of an electromagnetic field formed around the antenna conductor 13 is less likely to occur. In particular, due to the provision of the constricted section 111 of the dielectric substrate 11, thermal conductivity from the region to be heated H to the antenna conductor-provided region X is hindered in the antenna device 1B. Accordingly, the antenna device 1B is even less likely to suffer distortion of the antenna conductor 13 as compared with the antenna device 1A. As a result, the antenna device 1B is even less likely to suffer deterioration in antenna characteristic caused by distortion of the antenna conductor 13 as compared with the antenna device 1A.

### Supplementary Notes on Embodiment 1

The above description of Embodiment 1 has discussed a configuration in which the heating wire 16 such as a nichrome wire is provided inside the dielectric substrate 11. Note, however, that the present invention is not limited to such a configuration. That is, it is possible to employ a configuration in which a heat conducting wire such as a copper wire is provided inside the dielectric substrate 11 instead of the heating wire 16. In this instance, bringing a heating element (e.g., a heat generating surface of a Peltier element) into thermal contact with the heat conducting wire allows the dielectric substrate 11 and the ground conductor 12 to be heated. In this instance, the antenna device 1 bends so that the first main surface of the dielectric substrate 11 forms a protruding surface. Further, by bringing a heat absorber (e.g., a heat absorbing surface of a Peltier element) into thermal contact with the heat conducting wire, it is possible to cool the dielectric substrate 11 and the ground conductor 12. In this instance, the antenna device 1 bends so that the second main surface of the dielectric substrate 11 forms a protruding surface. Note that Embodiment 2 (described later) will discuss a configuration in which the integrated circuit 15, which is a heating element, is brought into thermal contact with the heat conducting wire so that the dielectric substrate 11 and the ground conductor 12 are heated.

### Embodiment 2

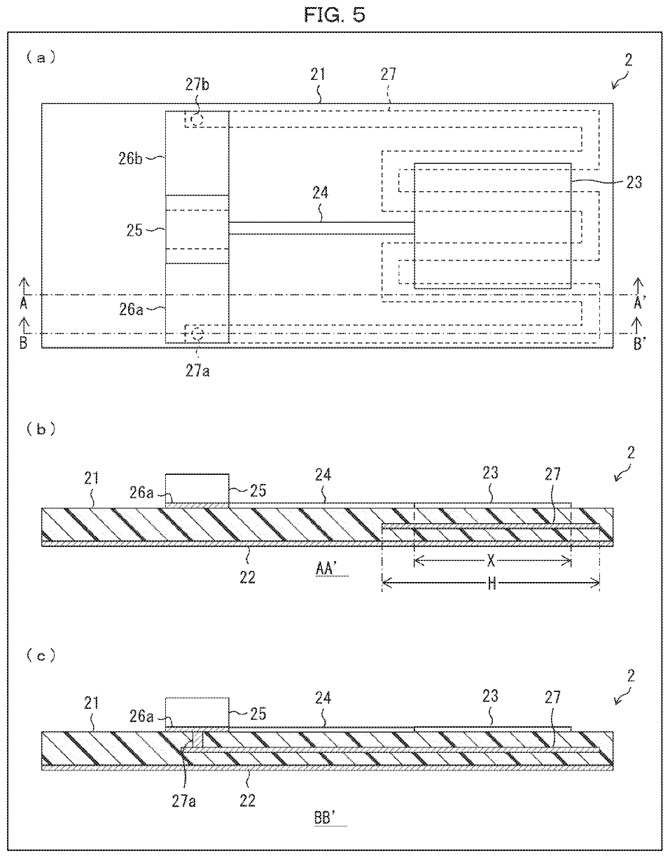

The following description will discuss, with reference to FIG. 5, a configuration of an antenna device 2 in accordance with Embodiment 2 of the present invention. (a) of FIG. 5 is a plan view of the antenna device 2, (b) of FIG. 5 is an AA′ cross-sectional view of the antenna device 2, and (c) of FIG. 5 is a BB′ cross-sectional view of the antenna device 2.

As illustrated in FIG. 5, the antenna device 2 includes a dielectric substrate 21, a ground conductor 22, an antenna conductor 23, a signal line 24, an integrated circuit 25, heat conducting plates 26a and 26b, and a heat conducting wire 27.

The dielectric substrate 21, the ground conductor 22, the antenna conductor 23, the signal line 24, and the integrated circuit 25 included in the antenna device 2 in accordance with Embodiment 2 are configured similarly to the dielectric substrate 11, the ground conductor 12, the antenna conductor 13, the signal line 14, and the integrated circuit 15 included in the antenna device 1 in accordance with Embodiment 1, respectively. As such, the following description will discuss the heat conducting plates 26a and 26b and the heat conducting wire 27 included in the antenna device 2.

The heat conducting plate 26a is a plate-like member made of a thermally conductive material such as a metal, and is provided on a second main surface of the dielectric substrate 21. A portion of the heat conducting plate 26a is provided between the dielectric substrate 21 and the integrated circuit 25 so as to be in contact with a back surface of the integrated circuit 25. The heat conducting plate 26b is configured in a similar manner to the heat conducting plate 26a.

The heat conducting wire 27 is a linear or strip-shaped member made of a thermally conductive material such as a metal, and is provided inside the dielectric substrate 21. One end of the heat conducting wire 27 is in contact with the heat conducting plate 26a, which is provided on the second main surface of the dielectric substrate 21, through a via 27a. The other end of the heat conducting wire 27 is in contact with the heat conducting plate 26b, which is provided on the second main surface of the dielectric substrate 21, through a via 27b.

In the antenna device 2, the heat conducting plates 26a and 26b and the heat conducting wire 27 constitute a heat conduction path for conducting heat generated in the integrated circuit 25 to the dielectric substrate 21 and the ground conductor 22. Accordingly, while the integrated circuit 25 is operating, the dielectric substrate 21 and the ground conductor 22 are heated by heat generated by the integrated circuit 25.

Note that in a case where the heat conducting wire meanders inside the dielectric substrate 21, it is possible to selectively heat a portion of the dielectric substrate 21 and a portion of the ground conductor 22. In Embodiment 2, as illustrated in FIG. 5, the heat conducting wire 27 meanders in a region to be heated H including an antenna conductor-provided region X. Accordingly, in a case where the integrated circuit 25 generates heat, portions of the dielectric substrate 21 and the ground conductor 22 which portions are included in the region to be heated H are selectively heated. This causes the antenna device 2 to bend in the region to be heated H, so that a radiation direction of the antenna device 2 is changed. The antenna device 2 has an advantage that the radiation direction can be adjusted without use of electric power other than electric power for operating the integrated circuit 25.

Aspects of the present invention can also be expressed as follows:

The antenna device (1, 2) in accordance with each embodiment of the present invention is an antenna device, including: a dielectric substrate (11, 21); a ground conductor (12, 22) provided on a first main surface of the dielectric substrate (11, 21) and made of a conductor material having a thermal expansion coefficient higher than that of a dielectric material of which the dielectric substrate (11, 21) is made; an antenna conductor (13, 23) provided on a second main surface of the dielectric substrate (11, 21); and a heating/cooling mechanism which heats the dielectric substrate (11, 21) and the ground conductor (12, 22).

According to the above configuration, in a case where the ground conductor (12, 22) and the dielectric substrate (11, 21) are heated with use of the heating/cooling mechanism, the antenna device (1, 2) bends so that the first main surface of the dielectric substrate (11, 21) forms a protruding surface. This is because the thermal expansion coefficient of the ground conductor (12, 22) is higher than that of the dielectric substrate (11, 21). Conversely, in a case where the ground conductor (12, 22) and the dielectric substrate (11, 21) are cooled with use of the heating/cooling mechanism, the antenna device (1, 2) bends so that the second main surface of the dielectric substrate (11, 21) forms a protruding surface. This is because the thermal expansion coefficient of the ground conductor (12, 22) is higher than that of the dielectric substrate (11, 21). As a result, the orientation of the antenna conductor (13, 23) is changed, and the radiation direction of the antenna device (1, 2) is changed, accordingly. By controlling the heating/cooling mechanism so as to adjust (i) an amount of heat conducted from the heating/cooling mechanism to the ground conductor (12, 22) and the dielectric substrate (11, 21) (in the case of heating) or (ii) an amount of heat conducted from the ground conductor (12, 22) and the dielectric substrate (11, 21) to the heating/cooling mechanism (in the case of cooling), it is possible to adjust the radiation direction of the antenna device (1, 2) with a constant level of accuracy. Moreover, according to the above configuration, there is no need to add expensive components to the antenna device (1, 2) in order to adjust the radiation direction. Therefore, according to the above configuration, the substrate-type antenna device (1, 2) whose radiation direction is adjustable can be provided at a lower cost than in the case of a conventional substrate-type antenna device.

In Modified Example, the antenna device (1) in accordance with Embodiment 1 is preferably configured such that in a case where a region of the antenna device (1) in which region the antenna conductor (13) is provided is defined as a first region (X) and a region of the antenna device (1) which region does not include the first region is defined as a second region (H), the heating/cooling mechanism selectively heats (i) a portion of the dielectric substrate (11) which portion is included in the second region (H) and (ii) a portion of the ground conductor (12) which portion is included in the second region (H).

According to the above configuration, a region (the second region) selectively heated or cooled by the heating/cooling mechanism, i.e., a region in which the antenna device (1) bends, does not include a region (the first region) in which the antenna conductor (13) is provided. As such, even in a case where the antenna device (1, 2) bends, the antenna conductor (13) is less likely to be distorted. Accordingly, deterioration in antenna characteristic caused by distortion of the antenna conductor (13) is less likely to occur.

In Modified Example, the antenna device (1) in accordance with Embodiment 1 is preferably configured such that the dielectric substrate (11) includes a constricted section (111) provided between the first region (X) and the second region (H).

According to the above configuration, the presence of the constricted section (111) inhibits (i) heat conduction from the region (the second region) selectively heated by the heating/cooling mechanism to the region in which the antenna conductor (13) is provided or (ii) heat conduction from the region in which the antenna conductor (13) is provided to the region (second region) selectively cooled by the heating/cooling mechanism. This makes it less likely for the antenna device (1) to bend in the region in which the antenna conductor (13) is provided. Accordingly, distortion of the antenna conductor (13) is even less likely to occur, and as a result, deterioration in antenna characteristic caused by distortion of the antenna conductor (13) is even less likely to occur.

The antenna device (1) in accordance with Embodiment 1 is preferably configured such that the heating/cooling mechanism is a heating wire (16) provided inside the dielectric substrate (11).

According to the above configuration, controlling a voltage applied to the heating wire (16) allows accurate adjustment of an amount of heat supplied from the heating wire (16) to the ground conductor and the dielectric substrate (11). This enables accurate adjustment of the radiation direction of the antenna device (1).

The antenna device (2) in accordance with Embodiment 2 is preferably configured such that the antenna device (2) further includes an integrated circuit (25) which is mounted on a surface (the first main surface or the second main surface) of the dielectric substrate (21) and which is connected to the antenna conductor (23) via a signal line (24), the heating/cooling mechanism being a heat conducting wire (27) which is provided inside the dielectric substrate (21) so as to be in thermal contact with the integrated circuit (25). Note that the heat conducting wire (27) refers to a linear member made of a heat conductive material.

According to the above configuration, the ground conductor (22) and the dielectric substrate (21) can be heated without use of electric power other than electric power for operating the integrated circuit (25). This allows the radiation direction of the antenna device (2) to be adjusted without use of electric power other than the electric power for operating the integrated circuit (25).

Note that the present invention encompasses a wireless device, including: the antenna device (1, 2); and a control section which controls the heating/cooling mechanism of the antenna device (1, 2).

Supplementary Notes

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Antenna device

11 Dielectric substrate

12 Ground conductor

13 Antenna conductor

14 Signal line

15 Integrated circuit

16 Heating wire (heating/cooling mechanism)

2 Antenna device

21 Dielectric substrate

22 Ground conductor

23 Antenna conductor

24 Signal line

25 Integrated circuit

26a Heat conducting plate

26b Heat conducting plate

27 Heat conducting wire (heating/cooling mechanism)

1. An antenna device, comprising:
a dielectric substrate;
a ground conductor provided on a first main surface of the dielectric substrate and made of a conductor material having a thermal expansion coefficient higher than that of a dielectric material constituting the dielectric substrate;
an antenna conductor provided on a second main surface of the dielectric substrate; and
a heating/cooling mechanism which heats or cools the dielectric substrate and the ground conductor.

2. The antenna device as set forth in claim 1, wherein
in a case where a region of the antenna device in which region the antenna conductor is provided is defined as a first region and a region of the antenna device which region does not include the first region is defined as a second region,
the heating/cooling mechanism selectively heats (i) a portion of the dielectric substrate which portion is included in the second region and (ii) a portion of the ground conductor which portion is included in the second region.

3. The antenna device as set forth in claim 2, wherein the dielectric substrate includes a constricted section provided between the first region and the second region.

4. The antenna device as set forth in claim 1, wherein the heating/cooling mechanism is a heating wire provided inside the dielectric substrate.

5. The antenna device as set forth in claim 1, further comprising an integrated circuit which is mounted on one or both of the first main surface and the second main surface of the dielectric substrate and which is connected to the antenna conductor via a signal line,
the heating/cooling mechanism being a heat conducting wire which is provided inside the dielectric substrate so as to be in thermal contact with the integrated circuit.

6. A wireless device, comprising:
an antenna device recited in claim 1; and
a control section which controls the heating/cooling mechanism of the antenna device.

7. A method for adjusting a radiation direction of an antenna device,
the antenna device including:
a dielectric substrate;
a ground conductor provided on a first main surface of the dielectric substrate and made of a conductor material having a thermal expansion coefficient higher than that of a dielectric material constituting the dielectric substrate; and
an antenna conductor provided on a second main surface of the dielectric substrate,
the method comprising:
a heating and cooling step of controlling an orientation of the antenna conductor by heating or cooling the dielectric substrate and the ground conductor.
